(19) United States
(12) Patent Application Publication
(10) Pub. No.: US 2015/0191620 A1
(43) Pub. Date: Jul. 9, 2015

(54) Fast-Drying, Radiation-Curable Coating Compounds

(71) Applicant: BASF SE, Ludwigshafen (DE)

(72) Inventors: Erich Beck, Ladenburg (DE); Reinhold Schwalm, Wachenheim (DE)

(21) Appl. No.: 14/415,761

(22) PCT Filed: Jul. 12, 2013
(86) PCT No.: PCT/EP2013/064751

§ 371 Date: Jan. 20, 2015

Related U.S. Application Data
(60) Provisional application No. 61/673,742, filed on Jul. 20, 2012.

(30) Foreign Application Priority Data
Jul. 20, 2012 (EP) 12177220.6

(51) Int. Cl. C09D 133/14; B05D 3/06; C09D 133/08

(52) U.S. Cl. CPC C09D 133/14; C09D 133/08; B05D 3/067

(57) ABSTRACT

Described are low-viscosity radiation-curable coating compositions, which dry at a relatively low temperature to give coatings featuring high scratch resistance and flexibility. Also described are processes for producing the low-viscosity radiation-curable coating compositions, and the use thereof.

### CROSS-REFERENCE TO RELATED APPLICATIONS

This is application is the National Stage Entry of PCT/EP2013/0647514, filed Jul. 12, 2013, which claims priority to U.S. Provisional Application Ser. No. 61/673,742, filed Jul. 20, 2012, and European Patent Application 12177220.6, filed Jul. 20, 2012, the disclosures of which are incorporate herein by reference in their entireties.

### TECHNICAL FIELD

The present invention relates to low-viscosity radiation-curable coating compositions which dry at a relatively low temperature to give coatings featuring high scratch resistance, high flexibility, and low solvent demand and to processes for producing them, and to the use thereof.

### BACKGROUND

To achieve high scratch resistance by means of radiation-curable coating compositions, the compounds used ought to have a high (meth)acrylate group functionality. Such compounds, however, are usually decidedly viscous, and often lead to a brittle coating. To reduce the viscosity it is usual to use solvents, but that leads to emission of volatile organic constituents (VOCs). In order, moreover, to increase the flexibility, it would be desirable to use monomers which produce a soft coating, such as monofunctional alkyl(meth)acrylates, for example.

A hindrance which in the past often stood in the way of using alkyl(meth)acrylates in radiation-curable coating compositions was that such alkyl(meth)acrylates were injurious to health and also had a high volatility, meaning that staff were exposed to these substances when such alkyl(meth)acrylates were applied. However, such alkyl(meth)acrylates are beneficial feedstocks, and so their use would be desirable on economic grounds. A technical factor in favor of the alkyl(meth)acrylates is that in the value chain they can be prepared directly from (meth)acrylic acid, whereas (meth)acrylates of higher functionality, such as trimethylolpropane triacrylate, for example, are further down the chain. The latter are generally prepared from alkyl(meth)acrylates, and so are two steps behind (meth)acrylic acid in the value chain.

A frequent fault line in the use of such alkyl(meth)acrylates in radiation-curable coating compositions, however, is that in numerous radiation-curable coating compositions the alkyl(meth)acrylates lack sufficient compatibility.

Accordingly, it is desired to provide radiation-curable coating compositions of low viscosity which dry even at low temperatures and yield coatings combining high flexibility with high scratch resistance.

### SUMMARY

A first aspect of the invention is directed to a radiation-curable coating composition. In a first embodiment, a radiation-curable coating composition comprises: (A) at least one polyfunctional (meth)acrylate having a molecular weight of not more than 1000 g/mol and a functionality of at least four, (B) at least one monofuctional alkyl(meth)acrylate, which, as a homopolymer, has a glass transition temperature of not more than 0° C., (C) at least one urethane(meth)acrylate which has at least one free isocyanate group and at least one (meth)acrylate group, (D) at least one polyfunctional (meth)acrylate having a molecular weight of more than 1000 g/mol and a functionality of at least five, (E) optionally, at least one solvent selected from the group consisting of hydrocarbons, ketones, esters, alkoxylated alkanoic acid alkyl esters, ethers, and mixtures thereof, (F) optionally, at least one amine and/or alcohol, (G) optionally, at least one photoinitiator, and (H) optionally, at least one paint auxiliary.

In a second embodiment, the coating composition of the first embodiment is modified, wherein component (A) is selected from the group consisting of ditrimethylolpropane tetraacrylate, pentaerythritol tetraacrylate, and dipentaerythritol hexaacrylate.

In a third embodiment, the coating composition of the first and second embodiments is modified, wherein the alkyl(meth)acrylates (B) are (meth)acrylic esters of alkanols which have 2 to 12 carbon atoms.

In a fourth embodiment, the coating composition the first through third embodiments is modified, wherein component (B) selected from the group consisting of ethyl acrylate, propyl acrylate, isopropyl acrylate, n-butyl acrylate, n-hexyl acrylate, n-octyl acrylate, 2-ethylhexyl acrylate, 3-propylheptyl acrylate, n-decyl acrylate, lauryl acrylate, n-pentyl methacrylate, n-octyl methacrylate, n-decyl methacrylate, and lauryl methacrylate.

In a fifth embodiment, the coating composition the first through fourth embodiments is modified, wherein component (C) is the reaction product of at least one (cyclo)aliphatic diisocyanate or polyisocyanate (C1) with at least one compound (C2) having at least one isocyanate-reactive group and at least one (meth)acrylate group and also optionally, with at least one compound (C3) having at least two isocyanate-reactive groups.

In a sixth embodiment, the coating composition of the first through fourth embodiments is modified, wherein component (C) is a reaction product of a (cyclo)aliphatic diisocyanate with a hydroxyalkyl(meth)acrylate which has been obtained under reaction conditions under which both urethane groups and allophanate groups are formed, and so the (meth)acrylate groups are bonded at least partly via allophanate groups.

In a seventh embodiment, the coating composition of the first through sixth embodiments is modified, wherein component (D) selected from the group consisting of polyester(meth)acrylates, epoxy(meth)acrylates, and urethane(meth)acrylates.

In an eighth embodiment, the coating composition of the first through sixth embodiments is modified, wherein component (D) is a urethane(meth)acrylate having a (meth)acrylic group content of 1 to 5 mol per 1000 g of urethane(meth)acrylate.

In a ninth embodiment, the coating composition of the first through eighth embodiments is modified, wherein component (E) selected from the group consisting of n-butyl acetate, ethyl acetate, acetone, and methyl acetate.

In a tenth embodiment, the coating composition of the first through ninth embodiments is modified wherein, the coating composition comprises: (A) 2 to 50 weight %, (B) 5 to 90 weight %, (C) 2 to 50 weight %, (D) 1 to 40 weight %, (E) 0 to 50 weight %, (F) 0 to 10 weight %, (G) 0 to 8 weight %, (H) 0 to 15 weight %, with the proviso that the sum total is always 100 weight %.

A second aspect of the invention is related to a process. In an eleventh embodiment, a process for producing the coating composition the first through tenth embodiments comprises introducing components (A), (C), and (D) as an initial charge and metering in component (B) with mixing until a single-phase mixture is obtained.

In a twelfth embodiment, a process for producing the coating composition the first through tenth embodiments comprises introducing components (A), (B), and (D) as an initial charge and metering in component (C) in with mixing until a two-phase mixture is obtained, followed by metering addition of additional component (B) and also, optionally, solvent (E).

In a thirteenth embodiment, a process for coating a substrate comprises applying the coating composition the first through ninth embodiments to a substrate under an inert gas, then drying and curing under inert conditions with UV radiation.

### DETAILED DESCRIPTION

Provided are radiation-curable coating compositions comprising
(A) at least one polyfunctional (meth)acrylate having a molecular weight of not more than 1000 g/mol and a functionality of at least four,
(B) at least one monofuctional alkyl(meth)acrylate which as a homopolymer has a glass transition temperature of not more than 0° C.,
(C) at least one urethane(meth)acrylate which has at least one free isocyanate group and at least one (meth)acrylate group,
(D) at least one polyfunctional (meth)acrylate having a molecular weight of more than 1000 g/mol and a functionality of at least five,
(E) optionally at least one solvent selected from the group consisting of from the group consisting of hydrocarbons, ketones, esters, alkoxylated alkanoic acid alkyl esters, ethers, and mixtures thereof,
(F) optionally at least one amine and/or alcohol,
(G) optionally at least one photoinitiator, and
(H) optionally at least one paint auxiliary.

The coating compositions of the invention dry at low temperature and exhibit high flexibility, resulting, for example, in good flexing possibilities or puncturability of the coating, and also in a high scratch resistance, which is manifested, for example in good gloss retention by the coating.

In one or more embodiments, component (A) is at least one, one to four for example, specifically one to three, more specifically one to two, and very specifically one polyfunctional (meth)acrylate having a molecular weight of not more than 1000 g/mol, specifically not more than 800, and more specifically not more than 600 g/mol, and having a functionality of at least four, four to eight for example, and specifically four to six.

In one or more embodiments, component (A) comprises the (meth)acrylates of the corresponding polyfunctional alcohols, in other words alcohols having a functionality of at least four. Examples of such polyfunctional alcohols are ditrimethylolpropane, pentaerythritol, dipentaerythritol, diglycerol, and also sugar alcohols, such as, for example, sorbitol, mannitol, diglycerol, threitol, erythritol, adonitol (ribitol), arabitol (lyxitol), xylitol, dulcitol (galactitol), maltitol, or isomalt.

Likewise conceivable as polyfunctional alcohols are the one to twenty, and more specifically three to ten ethoxylated, propoxylated, or mixtures of ethoxylated and propoxylated, and more particularly exclusively ethoxylated, products of the above-mentioned alcohols.

In one specific embodiment component (A) is selected from the group consisting of ditrimethylolpropane tetraacrylate, pentaerythritol tetraacrylate, and dipentaerythritol hexaacrylate, which may optionally in each case be one to twenty ethoxylated, propoxylated, or mixtures of ethoxylated and propoxylated; the compound in question is more specifically pentaerythritol tetraacrylate.

In one or more embodiments, component (B) comprises at least one, one to four for example, specifically one to three, more specifically one or two, and very specifically one monofunctional alkyl(meth)acrylate which as a homopolymer has a glass transition temperature of not more than 0° C.

The alkyl(meth)acrylates (B) are specifically (meth)acrylic esters of alkanols which have 2 to 12 carbon atoms.

More specifically the alkyl(meth)acrylates (B) have a boiling point under atmospheric pressure of at least 140° C., very specifically of at least 200° C. This results in a low volatility on the part of the alkyl(meth)acrylates (B).

In one or more specific embodiments, component (B) is selected from the group consisting of ethyl acrylate, propyl acrylate, isopropyl acrylate, n-butyl acrylate, n-hexyl acrylate, n-octyl acrylate, 2-ethylhexyl acrylate, 3-propylheptyl acrylate, n-decyl acrylate, lauryl acrylate, n-pentyl methacrylate, n-octyl methacrylate, n-decyl methacrylate, and lauryl methacrylate.

In one or more embodiments, component (B) is n-butyl(meth)acrylate, 2-ethylhexyl acrylate, or 3-propylheptyl acrylate.

It is surprising here that despite the use of alkyl(meth)acrylates (B), which have a relatively low glass transition temperature, it is nevertheless possible to obtain scratch-resistant coatings. Furthermore, through the use of the alkyl(meth)acrylates (B) in the coating compositions of the invention for the purpose of achieving a low viscosity, it is possible to do largely or wholly without the use of solvents.

In one or more embodiments, component (C) is at least one, one to two for example, specifically one or two, and more specifically one urethane(meth)acrylate, which has at least one free isocyanate group and at least one (meth)acrylate group.

In one or more embodiments, component (C) has at least one, specifically at least two, isocyanate group(s).

In one or more embodiments, the NCO content (calculated as as 42 g/mol) of component (C) is at least 5 weight %, specifically from 10 to 25, more specifically 12 to 23, and very specifically 14 to 16 weight %.

In one or more embodiments, the viscosity of component (C) (in accordance with DIN EN ISO 3219 (shear rate D, 100 s⁻¹) at 23° C.) is 200 to 10 000 mPas, more specifically 400 to 5000, and very specifically 1000 to 2000 mPas.

In one or more embodiments, the average molar weight of component (C) is from 284 to 2000 g/mol, more specifically 350 to 1500, and very specifically from 400 to 1000 g/mol.

In one or more embodiments, component (C) has at least one, specifically one to three, more specifically at least two (meth)acrylate groups.

In one or more specific embodiment component (C) comprises compounds of the formula

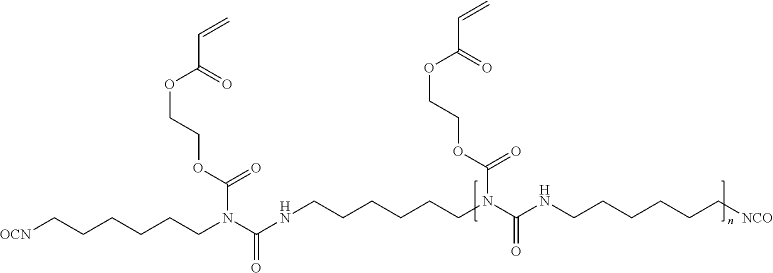

wherein

n is a positive number which on average is >1, specifically more than 1 and up to 5, more specifically at least 1.1 and up to 3.

The compounds (C) are suitable for improving the compatibility of components (B) and (D), which often tend toward separation, in the coating composition of the invention, hence functioning as solubilizers for these components.

It may be supposed, furthermore, that within the coating composition, the free isocyanate groups are reacted on curing in the atmosphere with moisture, from the air or from a primer already on the substrate, for example, and are converted into amino groups, which in turn are able to react with existing isocyanate groups, such that in the coating composition, as well as the radiation curing, there is also a further curing or postcrosslinking mechanism available.

In one or more embodiments, in general the component (C) is the reaction product
of at least one (cyclo)aliphatic diisocyanate or polyisocyanate (C1)
with at least one compound (C2) having at least one isocyanate-reactive group and at least one (meth)acrylate group and also
optionally with at least one compound (C3) having at least two isocyanate-reactive groups.

In one or more embodiments, compounds (C1) are aliphatic or cycloaliphatic—identified herein for short as (cyclo)aliphatic—diisocyanates and polyisocyanates having an NCO functionality of at least 1.8, specifically 1.8 to 5, and more specifically 2 to 4, and also their isocyanurates, biurets, allophanates, and uretdiones, which can be obtained from these parent diisocyanates in monomeric form by oligomerization.

In one or more embodiments, the isocyanate group content, calculated as NCO=42 g/mol, is generally from 5 to 25 weight %.

The diisocyanates are specifically isocyanates having 4 to 20 C atoms. Examples of typical diisocyanates are aliphatic diisocyanates such as tetramethylene diisocyanate, hexamethylene 1,6-diisocyanate, (1,6-diisocyanatohexane), octamethylene diisocyanate, decamethylene diisocyanate, dodecamethylene diisocyanate, tetradecamethylene diisocyanate, derivatives of lysine diisocyanate, tetramethylxylylene diisocyanate, trimethylhexane diisocyanate or tetramethylhexane diisocyanate, cycloaliphatic diisocyanates such as 1,4-, 1,3-, or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane(isophorone diisocyanate), 1,3- or 1,4-bis(isocyanatomethyl)cyclohexane, or 2,4-, or 2,6-diisocyanato-1-methylcyclohexane.

In one or more embodiments, mixtures of said diisocyanates may also be present.

In one or more specific embodiments, hexamethylene diisocyanate, 1,3-bis(isocyanatomethyl)cyclohexane, isophorone diisocyanate, and di(isocyanatocyclohexyl)methane are used, and specifically hexamethylene diisocyanate.

In one or more embodiments, suitable polyisocyanates include polyisocyanates containing isocyanurate groups, uretdione diisocyanates, polyisocyanates containing biuret groups, polyisocyanates containing urethane groups or allophanate groups, polyisocyanates comprising oxadiazinetrione groups, uretonimine-modified polyisocyanates of aliphatic diisocyanates having in all 6 to 20 C atoms, and/or cycloaliphatic diisocyanates having a total of 6 to 20 C atoms.

The di- and polyisocyanates which can be used, in one or more embodiments, have an isocyanate group (calculated as NCO, molecular weight=42) content of 10% to 60% by weight, based on the di- and polyisocyanate (mixture), specifically 15% to 60% by weight, and more specifically 20% to 55% by weight.

In one or more specific embodiments, aliphatic and/or cycloaliphatic di- and polyisocyanates, examples being the aliphatic and/or cycloaliphatic diisocyanates stated above, or mixtures thereof are used.

Preference extends to
1) Polyisocyanates containing isocyanurate groups and derived from aliphatic and/or cycloaliphatic diisocyanates. Particular preference is given in this context to the corresponding aliphatic and/or cycloaliphatic isocyanatoisocyanurates and in particular to those based on hexamethylene diisocyanate and isophorone diisocyanate. The isocyanurates present are, in particular, tris-isocyanatoalkyl and/or tris-isocyanatocycloalkyl isocyanurates, which constitute cyclic trimers of the diisocyanates, or are mixtures with their higher homologs containing more than one isocyanurate ring. The isocyanatoisocyanurates generally have an NCO content of 10% to 30% by weight, in particular 15% to 25% by weight, and an average NCO functionality of 3 to 4.5.
2) Uretdione diisocyanates with aliphatically and/or cycloaliphatically attached isocyanate groups, specifically aliphatically or cycloaliphatically attached, and in particular those derived from hexamethylene diisocyanate or isophorone diisocyanate. Uretdione diisocyanates are cyclic dimerization products of diisocyanates. The uretdione diisocyanates can be used in the preparations as a sole component or in a mixture with other polyisocyanates, particularly those specified under 1).
3) Polyisocyanates containing biuret groups and having cycloaliphatically or aliphatically attached isocyanate groups, especially tris(6-isocyanatohexyl)biuret or its mixtures with its higher homologs. These polyisocyanates containing biuret groups generally have an NCO content of 18 to 25 weight % and an average NCO functionality of 3 to 4.5.
4) Polyisocyanates containing urethane and/or allophanate groups and having aliphatically or cycloaliphatically attached isocyanate groups, such as may be obtained, for example, by reacting excess amounts of hexamethylene diisocyanate or of isophorone diisocyanate with polyhydric alcohols such as, for example, trimethylolpropane, neopentyl glycol, pentaerythritol, 1,4-butanediol, 1,6-hexanediol, 1,3-propanediol, ethylene glycol, diethylene glycol, glycerol, 1,2-dihydroxypropane, or mixtures thereof, or specifically with at least one compound (C2), specifically 2-hydroxyethyl (methyl)acrylate. These polyisocyanates containing urethane and/or allophanate groups generally have an NCO content of 12 to 20 weight % and an average NCO functionality of at least 2, specifically at least 2.1 and more specifically 2.5 to 3.
5) Polyisocyanates comprising oxadiazinetrione groups, derived specifically from hexamethylene diisocyanate or isophorone diisocyanate. Polyisocyanates of this kind comprising oxadiazinetrione groups are preparable from diisocyanate and carbon dioxide. It may, though, be necessary to bear in mind the above-noted content of oxadiazinetrione groups.
6) Uretonimine-modified polyisocyanates.

Polyisocyanates 1) to 6) may be used in a mixture, including optionally in a mixture with diisocyanates.

In one or more embodiments, compounds (C2) are those which carry at least one isocyanate-reactive group and at least one (meth)acrylate group.

In one specific embodiment of the invention the compound (C1) is made up of a compound having precisely one isocyanate-reactive group and at least one (meth)acrylate group, one to five (meth)acrylate groups for example, more specifically one four, and very specifically one to three (meth)acrylate groups.

The components (C2) specifically have a molar weight below 2000 g/mol, more specifically below 1500 g/mol, very specifically below 1000 g/mol, and in particular below 750 g/mol. Specific compounds (C2) have a molar weight below 500 or even below 300 g/mol.

Examples of possible isocyanate-reactive groups include —OH, —SH, —NH₂, and —NHR¹, R¹ being hydrogen or an alkyl group comprising 1 to 4 carbon atoms, such as methyl, ethyl, n-propyl, isopropyl, n-butyl, isobutyl, sec-butyl, or tert-butyl, for example.

Examples of possible components (C2) include monoesters of acrylic acid or methacrylic acid with diols or polyols having specifically 2 to 20 C atoms and at least two hydroxyl groups, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,2-, 1,3- or 1,4-butanediol, 1,5-pentanediol, neopentyl glycol, 1,6-hexanediol, 2-methyl-1,5-pentanediol, 2-ethyl-1,4-butanediol, 1,4-dimethylolcyclo-hexane, 2,2-bis(4-hydroxycyclohexyl)propane, glycerol, trimethylolethane, trimethylolpropane, trimethylolbutane, pentaerythritol, ditrimethylolpropane, erythritol, sorbitol, polyTHF having a molar weight between 162 and 2000, poly-1,3-propanediol having a molar weight between 134 and 400 or polyethylene glycol having a molar weight between 238 and 458. In addition it is also possible to use esters or amides of (meth)acrylic acid with amino alcohols, examples being 2-aminoethanol, 2-(methylamino)ethanol, 3-amino-1-propanol, 1-amino-2-propanol or 2-(2-aminoethoxy)ethanol, 2-mercaptoethanol or polyaminoalkanes, such as ethylenediamine or diethylenetriamine.

In addition, unsaturated polyetherols or polyesterols or polyacrylate polyols having an average OH functionality of 2 to 10 are also suitable, albeit less specifically.

Examples of amides of ethylenically unsaturated carboxylic acids with amino alcohols are hydroxyalkyl(meth)acrylamides such as N-hydroxymethylacrylamide, N-hydroxymethyl-methacrylamide, N-hydroxyethylacrylamide, N-hydroxyethylmethacrylamide, 5-hydroxy-3-oxapentyl(meth)acrylamide, N-hydroxyalkylcrotonamides such as N-hydroxymethylcrotonamide, or N-hydroxyalkylmaleimides such as N-hydroxyethylmaleimide.

In one or more specific embodiments, 2-hydroxyethyl(meth)acrylate, 2- or 3-hydroxypropyl(meth)acrylate, 1,4-butanediol mono(meth)acrylate, neopentyl glycol mono(meth)acrylate, 1,5-pentanediol mono(meth)acrylate, 1,6-hexanediol mono(meth)acrylate, glycerol di(meth)acrylate, trimethylolpropane di(meth)acrylate, pentaerythritol tri(meth)acrylate, 2-aminoethyl(meth)acrylate, 2-aminopropyl(meth)acrylate, 3-aminopropyl(meth)acrylate, 4-aminobutyl(meth)acrylate, 6-aminohexyl (meth)acrylate, 2-thioethyl(meth)acrylate, 2-aminoethyl(meth)-acrylamide, 2-aminopropyl(meth)acrylamide, 3-aminopropyl(meth)acrylamide, 2-hydroxyethyl(meth)acrylamide, 2-hydroxypropyl(meth)acrylamide or 3-hydroxypropyl(meth)-acrylamide. Particular preference is given to 2-hydroxyethyl acrylate, 2-hydroxyethyl methacrylate, 2- or 3-hydroxypropyl acrylate, 1,4-butanediol monoacrylate, 3-(acryloyloxy)-2-hydroxypropyl(meth)acrylate, and the monoacrylates of polyethylene glycol with a molar mass of 106 to 238 are used.

In one specific embodiment, component (C2) is selected from the group consisting of 2-hydroxyethyl acrylate, 2-hydroxyethyl methacrylate, 2- or 3-hydroxypropyl acrylate, and 1,4-butanediol monoacrylate, 1,2- or 1,3-diacrylate of glycerol, trimethylolpropane diacrylate, pentaerythritol triacrylate, ditrimethylolpropane triacrylate, and dipentaerythritol pentaacrylate, specifically from 2-hydroxyethyl acrylate and 2-hydroxyethyl methacrylate.

In one or more embodiments, compounds suitable as component (C3) are those which have at least two isocyanate-reactive groups, examples being —OH, —SH, —NH₂ or —NHR², in which R² independently at each occurrence can be hydrogen, methyl, ethyl, isopropyl, n-propyl, n-butyl, isobutyl, sec-butyl or tert-butyl.

These are, specifically, diols containing 2 to 20 carbon atoms, examples being ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol, 1,10-decanediol, bis(4-hydroxycyclohexane)isopropylidene, tetramethylcyclobutanediol, 1,2-, 1,3- or 1,4-cyclohexanediol, cyclooctanediol, norbornanediol, pinanediol, decalindiol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3-, and 1,4-cyclohexane-dimethanol, 1,2-, 1,3- or 1,4-cyclohexanediol, polyTHF with a molar mass between 162 and 2000, poly-1,2-propanediol or poly-1,3-propanediol with a molar mass between 134 and 1178 or polyethylene glycol with a molar mass between 106 and 2000, and aliphatic diamines, such as methylene-, and is opropylidenebis(cyclohexylamine), piperazine, 1,2-, 1,3- or 1,4-diaminocyclohexane, 1,2-, 1,3- or 1,4-cyclohexanebis(methylamine), etc., dithiols or polyfunctional alcohols, secondary or primary amino alcohols, such as ethanolamine, monopropanolamine, etc., or thio alcohols, such as thioethylene glycol.

Particularly suitable here are the cycloaliphatic diols, such as, for example bis(4-hydroxycyclo-hexane)isopropylidene, tetramethylcyclobutanediol, 1,2-, 1,3-, or 1,4-cyclohexanediol, 1,1-, 1,2-, 1,3-, and 1,4-cyclohexanedimethanol, cyclooctanediol, or norbornanediol.

The optional compound (C3) may additionally be at least one compound having at least three isocyanate-reactive groups.

For example, components (C3) may have 3 to 6, specifically 3 to 5, more specifically 3 to 4, and very specifically 3 isocyanate-reactive groups.

The molecular weight of the components (C3) is generally not more than 2000 g/mol, specifically not more than 1500 g/mol, more specifically not more than 1000 g/mol, and very specifically not more than 500 g/mol.

These are polyols having specifically 2 to 20 carbon atoms, examples being trimethylolbutane, trimethylolpropane, trimethylolethane, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, and isomalt, more specifically trimethylolpropane, pentaerythritol, and glycerol, and very specifically trimethylolpropane.

In a specific embodiment, the reaction product of a (cyclo)aliphatic diisocyanate, specifically hexamethylene 1,6-diisocyanate, with a hydroxyalkyl(meth)acrylate, specifically 2-hydroxyethyl acrylate, 2-hydroxyethyl methacrylate, 2-hydroxypropyl acrylate, or 2-hydroxypropyl methacrylate, more specifically 2-hydroxyethyl acrylate or 2-hydroxypropyl acrylate, and very specifically 2-hydroxyethyl acrylate is used as compound (C).

In one particular embodiment, this reaction product is obtained under reaction conditions under which urethane groups and allophanate groups are formed, and so the (meth)acrylate groups are attached at least partly via allophanate groups. In this way the product obtained is of particularly low viscosity as measured on the molecular weight.

A process for preparing such products (C) and products (C) is described in WO 00/39183 A, particularly from page 4, line 17 to page 6, line 6, and also page 8, line 44 to page 10, line 26, therein, and also in the examples therein, express reference being made to these passages in the context of the present disclosure.

One such product is available commercially under the trade name Laromer® LR 9000 from BASF SE, Ludwigshafen, for example.

In one or more embodiments, component (D) is at least one, one to three for example, specifically one or two, and more specifically one polyfunctional (meth)acrylate having a molecular weight of at least 700 g/mol, specifically more than 1000, and more specifically 2000 g/mol, and having a functionality of at least five, specifically five to eight, more specifically five to seven, and very specifically five to six. In general the molar weight of component (D) is not more than 3000 g/mol.

Specifically component (D) is selected from the group consisting of polyester(meth)acrylates, epoxy(meth)acrylates, and urethane(meth)acrylates, specifically from polyester(meth)acrylates and urethane(meth)acrylates, and more specifically it is a urethane(meth)acrylate.

Polyester(meth)acrylates are (meth)acrylates of polyester polyols having the corresponding desired functionality.

Polyester polyols are known for example from Ullmanns Encyklopadie der technischen Chemie, 4th edition, volume 19, pp. 62 to 65. In one or more specific embodiments, polyester polyols obtained by reacting dihydric alcohols with dibasic carboxylic acids are used. In one or more embodiments, in lieu of the free polycarboxylic acids it is also possible to use the corresponding polycarboxylic anhydrides or corresponding polycarboxylic esters of lower alcohols or mixtures thereof to prepare the polyester polyols. The polycarboxylic acids may be aliphatic, cycloaliphatic, araliphatic, aromatic or heterocyclic and may optionally be substituted, by halogen atoms for example, and/or unsaturated. Examples thereof that may be mentioned include the following:

oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄ alkyl esters for example, specifically methyl, ethyl or n-butyl esters, of said acids are used. In one or more embodiments, dicarboxylic acids of the general formula HOOC—(CH₂)_{y}—COOH, y being a number from 1 to 20, specifically an even number from 2 to 20; more specifically succinic acid, adipic acid, sebacic acid, and dodecanedicarboxylic acid are used.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, polyTHF having a molar mass between 162 and 2000, poly-1,3-propanediol having a molar mass between 134 and 1178, poly-1,2-propanediol having a molar mass between 134 and 898, polyethylene glycol having a molar mass between 106 and 458, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3-, and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which optionally may have been alkoxylated as described above.

In one or more embodiments, the alcohols used are those of the general formula HO—(CH₂)ₓ—OH, x being a number from 1 to 20, specifically an even number from 2 to 20. In one or more specific embodiments, ethylene glycol, butane-1,4-diol, hexane-1,6-diol, octane-1,8-diol, and dodecane-1,12-diol are used. In a very specific embodiment, neopentyl glycol is used.

Also suitable are lactone-based polyesterdiols, which are homopolymers or copolymers of lactones, specifically hydroxyl-terminated adducts of lactones with suitable difunctional starter molecules. Suitable lactones include, specifically, those deriving from compounds of the general formula HO—(CH₂)_{z}—COOH, z being a number from 1 to 20 and it being possible for an H atom of a methylene unit to have been substituted by a C₁ to C₄ alkyl radical. Examples are 8-caprolactone, β-propiolactone, gamma-butyrolactone and/or methyl-c-caprolactone, 4-hydroxybenzoic acid, 6-hydroxy-2-naphthoic acid or pivalolactone, and mixtures thereof. Examples of suitable starter components are the low molecular weight dihydric alcohols specified above as a constituent component for the polyester polyols. The corresponding polymers of ε-caprolactone are particularly preferred. Lower polyesterdiols or polyetherdiols as well can be used as starters for preparing the lactone polymers. In lieu of the polymers of lactones it is also possible to use the corresponding, chemically equivalent polycondensates of the hydroxycarboxylic acids corresponding to the lactones.

Epoxy(meth)acrylates are obtainable by reacting epoxides with (meth)acrylic acid. Examples of epoxides contemplated include epoxidized olefins, aromatic glycidyl ethers, or aliphatic glycidyl ethers, specifically those of aromatic or aliphatic glycidyl ethers.

Epoxidized olefins may be, for example, ethylene oxide, propylene oxide, isobutylene oxide, 1-butene oxide, 2-butene oxide, vinyloxirane, styrene oxide, or epichlorohydrin, specifically ethylene oxide, propylene oxide, isobutylene oxide, vinyloxirane, styrene oxide, or epichloro-hydrin, more specifically ethylene oxide, propylene oxide, or epichlorohydrin, and very specifically ethylene oxide and epichlorohydrin.

Aromatic glycidyl ethers are, for example bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octa-hydro-4,7-methano-5H-indene (CAS No. [13446-85-0]), tris[4-(2,3-epoxypropoxy)phenyl]-methane isomers (CAS No. [66072-39-7]), phenol-based epoxy novolaks (CAS No. [9003-35-4]), and cresol-based epoxy novolaks (CAS No. [37382-79-9]).

Examples of aliphatic glycidyl ethers are 1,4-butanediol diglycid ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ethers of polypropylene glycol (α,ω-bis(2,3-epoxypropoxy)poly(oxypropylene) (CAS No. [16096-30-3]) and of hydrogenated bisphenol A (2,2-bis[4-(2,3-epoxypropoxy)cyclohexyl]propane, CAS No. [13410-58-7]).

In one or more embodiments, aliphatic glycidyl ethers are the formal reaction products of epichlorohydrin with polyethylene glycol with a molar mass of 62 to 1000, polypropylene glycol with a molar mass of 76 to 1000, polyTHF with a molar mass of 162 to 2000, polycaprolactonediols with a molar mass of up to 1000, or polyglycerol with a molar mass of up to 1000 g/mol.

The epoxide(meth)acrylates specifically have a number-average molar weight Mₙ of 200 to 20 000, more specifically of 200 to 10 000 g/mol, and very specifically of 250 to 3000 g/mol; the amount of (meth)acrylic groups is specifically 1 to 5, more specifically 2 to 4, per 1000 g of epoxide(meth)acrylate or vinyl ether epoxide (determined by gel permeation chromatography with polystyrene as standard and tetrahydrofuran as eluent).

Urethane(meth)acrylates are obtainable, for example, by reacting polyisocyanates with hydroxyalkyl(meth)acrylates and optionally chain extenders such as diols, polyols, diamines, polyamines, or dithiols or polythiols.

Such urethane(meth)acrylates comprise as synthesis components substantially:
(a) at least one organic aliphatic, aromatic, or cycloaliphatic di- or polyisocyanate, specifically a (cyclo)aliphatic polyisocyanates,
(b) at least one compound having at least one isocyanate-reactive group and at least one (meth)acrylate group, and
(c) optionally at least one compound having at least two isocyanate-reactive groups.

The components (a), (b), and (c) may be the same as described above as components (C1), (C2), and (C3) in the case of component (C).

The urethane(meth)acrylates specifically have a number-average molar weight Mₙ of 500 to 20 000, more particularly of 500 to 10 000, more specifically 600 to 3000 g/mol (determined by gel permeation chromatography with tetrahydrofuran and polystyrene as standard).

The urethane(meth)acrylates specifically have a (meth)acrylic group content of 1 to 5, more specifically of 2 to 4, mol per 1000 g of urethane(meth)acrylate.

In one specific embodiment the urethane(meth)acrylates are of the kind described in WO 2006/069690 A1, particularly page 1, line 35 to page 10, line 20 and the examples therein.

In one or more embodiments, the product in question is the reaction product of the abovementioned component (C) with a compound having precisely one isocyanate-reactive group and at least two, specifically two to five, more specifically two to four, very specifically two or three (meth)acrylate groups. With very particular preference the compound (D) is the reaction product of compounds (C) as described in WO 00/39183 A, particularly from page 4, line 17 to page 6, line 6 therein, with a compound having precisely one isocyanate-reactive group and at least two, specifically two to five, more specifically two to four, and very specifically two or three (meth)acrylate groups.

A product of this kind is available commercially under the trade name Laromer® UA 9050 from BASF SE, Ludwigshafen, for example.

Particularly in the case where urethane(meth)acrylates are used as compound (D), the urethane(meth)acrylates, as a result of their preparation, are obtained as a mixture of the compounds (A) and (D), and so may be introduced already as a mixture into the coating compositions of the invention.

In one or more embodiments, the optional component (E) is at least one solvent selected from the group consisting of hydrocarbons, ketones, esters, alkoxylated alkanoic acid alkyl esters, ethers, and mixtures thereof.

In one or more embodiments, aromatic hydrocarbon mixtures are those which comprise predominantly aromatic C₇ to C₁₄ hydrocarbons and may span a boiling range from 110 to 300° C., particularly toluene, o-, m-, or p-xylene, trimethylbenzene isomers, tetramethylbenzene isomers, ethylbenzene, cummene, tetrahydronaphthalene, and mixtures thereof.

Examples of such are the Solvesso® products from ExxonMobil Chemical, particularly Solvesso® 100 (CAS No. 64742-95-6, predominantly C₉ and C₁₀ aromatics, boiling range about 154-178° C.), 150 (boiling range about 182-207° C.) and 200 (CAS No. 64742-94-5), and also the Shellsol® products from Shell, Caromax® (e.g., Caromax® 18) from Petrochem Carless, and Hydrosol from DHC (e.g., as Hydrosol® A 170). Hydrocarbon mixtures of paraffins, cycloparaffins, and aromatics are also available commercially under the Kristalloel names (for example, Kristalloel 30, boiling range about 158-198° C., or Kristalloel 60: CAS No. 64742-82-1), white spirit (for example likewise CAS No. 64742-82-1) or solvent naphtha (light: boiling range about 155-180° C., heavy: boiling range about 225-300° C.). The aromatics content of such hydrocarbon mixtures is generally more than 90 weight %, specifically more than 95, more specifically more than 98, and very specifically more than 99 weight %. It may be useful to use hydrocarbon mixtures having a particularly reduced naphthalene content.

Examples of (cyclo)aliphatic hydrocarbons are decalin, alkylated decalin, and isomer mixtures of linear or branched alkanes and/or cycloalkanes.

The amount of aliphatic hydrocarbons is generally less than 5, specifically less than 2.5, and more specifically less than 1 weight %.

Esters are, for example, n-butyl acetate, ethyl acetate, 1-methoxyprop-2-yl acetate, and 2-methoxyethyl acetate.

Ethers are, for example, THF, dioxane, and also the dimethyl, diethyl or di-n-butyl ethers of ethylene glycol, diethylene glycol, triethylene glycol, propylene glycol, dipropylene glycol, or tripropylene glycol.

Ketones are, for example, acetone, diethyl ketone, ethyl methyl ketone, isobutyl methyl ketone, methyl amyl ketone, and tert-butyl methyl ketone.

In one or more embodiments, the solvents are n-butyl acetate, ethyl acetate, acetone, and methyl acetate.

In one specific embodiment, the solvents (E) are those from the above-recited solvent classes and individuals, which have an evaporation number in accordance with DIN 53170,1991-08 of up to 20, more specifically of up to 10.

In one or more embodiments, the optional component (F) is at least one amine and/or alcohol.

The components (F) may have one or more amino groups and/or hydroxyl groups, one to three for example, specifically one or two, and more specifically just one.

In one or more embodiments, the compounds (F) are alkanols and/or aminoalkanes which have one to 12 carbon atoms, more specifically C₁-C₆ alkanols.

Examples of monoalcohols are methanol, ethanol, isopropanol, n-propanol, n-butanol, isobutanol, sec-butanol, tert-butanol, ethylene glycol monomethyl ether, ethylene glycol monoethyl ether, 1,3-propanediol monomethyl ether, n-hexanol, n-heptanol, n-octanol, n-decanol, n-dodecanol (lauryl alcohol), and 2-ethylhexanol. Examples of monoamines are methylamine, ethylamine, isopropylamine, n-propylamine, n-butylamine, isobutylamine, sec-butylamine, tert-butylamine, n-pentylamine, n-hexylamine, n-heptylamine, n-octylamine, n-decylamine, n-dodecylamine, 2-ethylhexylamine, stearylamine, cetylamine, or laurylamine. Preferred amines are benzylamine and methoxypropylamine.

In one or more embodiments, the optional component (G) comprises at least one photoinitiator, specifically one to three and more specifically one photoinitiator, or mixtures of two photoinitiators.

As photoinitiators it is possible to use photoinitiators known to the skilled person, examples being those stated in “Advances in Polymer Science”, Volume 14, Springer Berlin 1974 or in K. K. Dietliker, Chemistry and Technology of UV- and EB-Formulation for Coatings, Inks and Paints, Volume 3; Photoinitiators for Free Radical and Cationic Polymerization, P. K. T. Oldring (ed.), SITA Technology Ltd, London.

Examples of those contemplated include phosphine oxides, benzophenones, a-hydroxyalkyl aryl ketones, thioxanthones, anthraquinones. acetophenones, benzoins and benzoin ethers, ketals, imidazoles, or phenylglyoxylic acids.

Photoinitiators contemplated are those as described in WO 2006/005491 A1, page 21, line 18 to page 22, line 2 (corresponding to US 2006/0009589 A1, paragraph [0150]), hereby made part of the present disclosure by reference.

The following compounds may be cited as examples of the individual classes:

Mono- or bisacylphosphine oxides, such as Irgacure® 819 (bis(2,4,6-trimethylbenzoyl)phenyl-phosphine oxide), of the kind described for example in EP-A 7 508, EP-A 57 474, DE-A 196 18 720, EP-A 495 751, or EP-A 615 980, examples being 2,4,6-trimethylbenzoyl-diphenylphosphine oxide (Lucirin® TPO), ethyl 2,4,6-trimethylbenzoylphenylphosphinate, and bis(2,6-dimethoxybenzoyl)-2,4,4-trimethylpentylphosphine oxide, benzophenone, 4-aminobenzophenone, 4,4′-bis(dimethylamino)benzophenone, 4-phenylbenzo-phenone, 4-chlorobenzophenone, Michler's ketone, o-methoxybenzophenone, 2,4,6-trimethylbenzophenone, 4-methylbenzophenone, 2,4-dimethylbenzophenone, 4-isopropylbenzophenone, 2-chlorobenzophenone, 2,2′-dichlorobenzophenone, 4-methoxybenzophenone, 4-propoxybenzophenone, or 4-butoxybenzophenone

1-benzoylcyclohexan-1- ol (1-hydroxycyclohexyl phenyl ketone), 2-hydroxy-2,2-dimethylaceto-phenone (2-hydroxy-2-methyl-1-phenylpropan-1-one), 1-hydroxyacetophenone, 1-[4-(2-hydroxyethoxy)phenyl]-2-hydroxy-2-methyl-1-prop an-1- one, polymer comprising in copolymerized form 2-hydroxy-2-methyl-1-(4-isopropen-2-ylphenyl)propan-1-one (Esacure® KIP 150)

10-thioxanthenone, thioxanthen-9-one, xanthen-9-one, 2,4-dimethylthioxanthone, 2,4-diethylthioxanthone, 2,4-diisopropylthioxanthone, 2,4-dichlorothioxanthone, and chloroxanthenone,

β-methylanthraquinone, tert-butylanthraquinone, anthraquinonecarbonyl acid esters, benz[de]anthracen-7-one, benz[a]anthracene-7,12-dione, 2-methylanthraquinone, 2-ethylanthraquinone, 2-tert-butylanthraquinone, 1-chloroanthraquinone, 2-amylanthraquinone

acetophenone, acetonaphthoquinone, valerophenone, hexanophenone, α-phenylbutyrophenone, p-morpholinopropiophenone, dibenzosuberone, 4-morpholinobenzophenone, p-diacetylbenzene, 4′-methoxyacetophenone, α-tetralone, 9-acetylphenanthrene, 2-acetylphenanthrene, 3-acetylphenanthrene, 3-acetylindole, 9-fluorenone, 1-indanone, 1,3,4-triacetylbenzene, 1-acetonaphthone, 2-acetonaphthone, 2,2-dimethoxy-2-phenylacetophenone, 2,2-diethoxy-2-phenylacetophenone, 1,1-dichloroacetophenone, 1-hydroxyacetophenone, 2,2-diethoxyacetophenone, 2-methyl-1-[4-(methylthio)phenyl]-2-morpholinopropan-1-one, 2,2-dimethoxy-1,2-diphenylethan-2-one, 2-benzyl-2-dimethylamino-1-(4-morpholinophenyl)butan-1-one

4-morpholinodeoxybenzoin, benzoin, benzoin isobutyl ether, benzoin tetrahydropyranyl ether, benzoin methyl ether, benzoin ethyl ether, benzoin butyl ether, benzoin isopropyl ether, and 7-H-benzoin methyl ether,

acetophenone dimethyl ketal, 2,2-diethoxyacetophenone, and benzil ketals, such as benzil dimethyl ketal,

phenylglyoxalic acids as described in DE-A 198 26 712, DE-A 199 13 353, or WO 98/33761, examples being phenylglyoxalic acid monoesters and diesters with polyethylene glycols having a molar mass of 62 to 500 g/mol

benzaldehyde, methyl ethyl ketone, 1-naphthaldehyde, triphenylphosphine, tri-o-tolylphosphine, and 2,3-butanedione.

Particularly noteworthy mixtures are 2-hydroxy-2-methyl- 1-phenylpropan-2-one and 1-hydroxy-cyclohexyl phenyl ketone, bis(2,6-dimethoxybenzoyl)-2,4,4-trimethylpentylphosphine oxide and 2-hydroxy-2-methyl-1-phenylpropan-1-one, benzophenone and 1-hydroxycyclohexyl phenyl ketone,

bis(2,6-dimethoxybenzoyl)-2,4,4-trimethylpentylphosphine oxide and 1-hydroxycyclohexyl phenyl ketone, 2,4,6-trimethylbenzoyldiphenylphosphine oxide and 2-hydroxy-2-methyl-1-phenylpropan-1-one,

2,4,6-trimethylbenzophenone and 4-methylbenzophenone, 2,4,6-trimethylbenzophenone and 4-methylbenzophenone and 2,4,6-trimethylbenzoyldiphenylphosphine oxide.

Likewise conceivable as photoinitiators are polymeric photoinitiators such as, for example, the diester of carboxymethoxybenzophenone with polytetramethylene glycols of various molar weights, specifically 200 to 250 g/mol (CAS 515136-48-8), and also CAS 1246194-73-9, CAS 813452-37-8, CAS 71512-90-8, CAS 886463-10-1, or other polymeric benzophenone derivatives, of the kind available commercially, for example, under the trade name Omnipol® BP from IGM Resins B.V., Waalwijk, The Netherlands or Genopol® BP1 from Rahn AG, Switzerland. Also conceivable, furthermore, are polymeric thioxanthones, an example being the diester of carboxymethoxythioxanthones with polytetramethylene glycols of various molar weights, of the kind available commercially, for example, under the trade name Omnipol® TX from IGM Resins B.V., Waalwijk, The Netherlands. Also conceivable, moreover, are polymeric a-amino ketones, as for example the diester of carboxyethoxythioxanthones with polyethylene glycols of various molar weights, of the kind available commercially, for example, under the trade name Omnipol® 910 or Omnipol® 9210 from IGM Resins B.V., Waalwijk, The Netherlands.

One specific embodiment uses, as photoinitiators, silsesquioxane compounds having at least one initiating group, of the kind described in WO 2010/063612 A1, particularly from page 2, line 21 to page 43, line 9 therein, as is hereby made part of the present disclosure by reference, specifically from page 2, line 21 to page 30, line 5, and also the compounds described in the examples of WO 2010/063612 A1.

Examples of additives and paint auxiliaries optional as (H) include antioxidants, stabilizers, activators (accelerators), fillers, pigments, dyes, dryers, antistatic agents, flame retardants, thickeners, rheological assistants, thixotropic agents, surface-active agents, viscosity modifiers, plasticizers, or chelating agents.

Furthermore, one or more thermally activatable initiators can be added, examples being potassium peroxodisulfate, dibenzoyl peroxide, cyclohexanone peroxide, di-tert-butyl peroxide, azobisisobutyronitrile, cyclohexylsulfonyl acetyl peroxide, diisopropyl percarbonate, tert-butyl peroctoate, or benzopinacol, and also, for example, those thermally activatable initiators which have a half-life at 80° C. of more than 100 hours, such as di-t-butyl peroxide, cumene hydroperoxide, dicumyl peroxide, t-butyl perbenzoate, silylated pinacols, which are available commercially, for example, under the trade name ADDID 600 from Wacker, or hydroxyl-containing amine N-oxides, such as 2,2,6,6-tetramethylpiperidine-N-oxyl, 4-hydroxy-2,2,6,6-tetramethylpiperidine-N-oxyl, etc.

Further examples of suitable initiators are described in “Polymer Handbook”, 2^{nd} edn., Wiley & Sons, New York.

Rheological assistants contemplated, as well as radically (co)polymerized (co)polymers, include customary organic and inorganic thickeners such as hydroxymethylcellulose, polymeric ureas, or bentonite.

The dryers may be, for example, monofunctional isocyanates, an example being phenyl isocyanate, or ortho esters, an example being methyl orthoformate or ethyl orthoformate.

Chelating agents used may be, for example, ethylenediamineacetic acid and salts thereof, and also β-diketones.

Suitable fillers comprise silicates, examples being silicates obtainable by hydrolysis of silicon tetrachloride, such as Aerosil® from Degussa, siliceous earth, talc, aluminum silicates, magnesium silicates, calcium carbonates, etc.

Suitable stabilizers comprise typical UV absorbers such as oxanilides, triazines, and benzotriazole (the latter available as Tinuvin® products from Ciba-Spezialitatenchemie), and benzophenones. These stabilizers can be used alone or together with suitable radical scavengers, examples being sterically hindered amines such as 2,2,6,6-tetramethylpiperidine, 2,6-di-tert-butylpiperidine, or derivatives thereof, such as bis(2,2,6,6-tetramethyl-4-piperidyl)sebacate, for example. Stabilizers are used customarily in amounts of 0.1 to 5.0 weight %, based on the solid components present in the preparation.

In one or more embodiments, the constitution of the coating compositions of the invention is specifically as follows:

(A) 2 to 50 weight %, specifically 15 to 40 weight %

(B) 5 to 90 weight %, specifically 30 to 60 weight %

(C) 2 to 50 weight %, specifically 15 to 40 weight %, more specifically 20 to 35 weight %

(D) 1 to 40 weight %, specifically 15 to 40 weight %

(E) 0 to 50 weight %, specifically 5 to 30 weight %

(F) 0 to 10 weight %, specifically 0 to 4 weight %

(G) 0 to 8 weight %, specifically 0 to 5 weight %

(H) 0 to 15 weight %, specifically 0 to 10 weight %

with the proviso that the sum total is always 100 weight %.

In one specific embodiment, the coating compositions of the invention can be prepared by initially introducing components (A), (C), and (D), generally resulting in a two-phase mixture, and metering component (B) into this two-phase mixture, with mixing, until a single-phase mixture is obtained. The desired target viscosity is achieved by metering of further (B) and also, optionally, solvent (E).

In another specific embodiment, the coating compositions of the invention can be prepared by initially introducing components (A), (B), and (D), and metering component (C) into this mixture until a two-phase mixture is obtained. A single-phase mixture and also the desired target viscosity are then achieved, again, by metered addition of further (B) and also, optionally solvent (E).

The polyurethanes of the invention can be used to coat a variety of substrates, such as, for example, wood, wood veneer, paper, paperboard, cardboard, textile, leather, nonwoven, plastics surfaces, glass, ceramic, mineral building materials, and coated or uncoated metals.

In the context of their use in coating materials, the polyurethanes of the invention can be used more particularly in primers, primer-surfacers, pigmented topcoats, and clearcoats in the sector of automotive refinishing or large-vehicle finishing. Such coating materials are particularly suitable for applications requiring particularly high application reliability, outdoor weathering resistance, optical qualities, and resistance to solvents, chemicals, and water, such as in automotive refinishing and large-vehicle finishing.

The coating of the substrates with the coating compositions of the invention takes place by customary methods known to the skilled person, with a coating composition of the invention, or a paint formulation comprising it, being applied in the desired thickness to the substrate to be coated, and optionally dried. This operation may if desired be repeated one or more times. Application to the substrate may be accomplished in a known way, as for example by spraying, troweling, knife coating, brushing, roller coating, rolling, casting, laminating, injection backmolding, or coextruding. The coating thickness is generally in a range from about 3 to 1000 g/m² and specifically 10 to 200 g/m².

Further disclosed is a method for coating substrates wherein the coating composition of the invention is applied to the substrate under an inert gas. Suitable inert gases are specifically nitrogen, noble gases, carbon dioxide, or combustion gases. This is especially preferred when explosive vapors would form in the case of application under an oxygen-containing atmosphere.

This coating method under inert gas is combined, with particular preference, with UV curing of the applied and dried coating composition, likewise under inert conditions. This has the particular advantage that excess coating composition such as overspray, for example, and/or the coating composition constituents present in the atmosphere, examples being solvents (E) and/or component (B), can be easily recovered.

By virtue of the fact that application and, optionally drying and curing take place under an inert gas, normally entailing containerization of the line, it is also readily possible to use the alkyl(meth)acrylates (B) in the coating composition of the invention, since any emissions of these compounds thus remain limited.

Moreover, a method for coating substrates is disposed wherein the coating composition of the invention or a paint formulation comprising it is admixed optionally with further, typical coatings additives and with resins curable thermally, chemically or by means of radiation, and is applied to the substrate and optionally dried, and cured with electron beams or by UV exposure under oxygen-containing atmosphere or, specifically, under inert gas, optionally at temperatures up to the level of the drying temperature.

Radiation curing takes place with high-energy light, such as UV light, or with electron beams. Radiation curing may take place at elevated temperatures. In that case a temperature above the T_{g} of the radiation-curable binder is preferred.

Radiation curing here means the radical polymerization of polymerizable compounds as a result of electromagnetic and/or particulate radiation, specifically UV light in the wavelength range of λ=200 to 700 nm and/or electronic radiation in the range from 150 to 300 keV, and more specifically with a radiation dose of at least 80, specifically 80 to 3000 mJ/cm².

Besides radiation curing there may also be other curing mechanisms involved, examples being thermal, moisture, chemical and/or oxidative curing, though this is less preferred.

The coating materials may be applied one or more times by any of a very wide variety of spraying methods, such as gas-pressure, airless, air-mix or electrostatic spraying methods, for example, using one- or two-component spraying equipment, or else by spraying, troweling, knifecoating, brushing, roller coating, rolling, casting, laminating, injection backmolding, or coextruding. Methods operated with gas pressure may be carried out by means of air or else inert gas.

The coating thickness is generally in a range from about 3 to 1000 g/m² and specifically 5 to 200, more specifically 10 to 100 g/m².

The drying and curing of the coatings take place in general under normal temperature conditions, i.e., without the coating being heated. However, the mixtures of the invention can also be used to produce coatings which, following application, are dried and cured at an elevated temperature, as for example at 40-250° C., specifically 40-150° C., and more particularly at 40 to 100 ° C. This is limited by the thermal stability of the substrate.

Particularly when at least one solvent is used, a particular advantage of the coating compositions of the invention is that they can be dried at a temperature of 20 to 100° C. within not more than 60, specifically not more than 30, more specifically not more than 15, very specifically not more than 10, and more particularly not more than 5 minutes. The criterion for drying here is the production of a blister-free coating after curing.

Further disclosed is a method for coating substrates wherein the coating composition of the invention or paint formulations comprising it, optionally admixed with thermally curable resins, is applied to the substrate, dried, and subsequently cured with electron beams or by UV exposure under an oxygen-containing atmosphere, or, specifically, under inert gas, optionally at temperatures up to the level of the drying temperature.

The method for coating substrates can also be implemented such that, after the coating composition of the invention, or paint formulations, has or have been applied, irradiation takes place first, with electron beams or by UV exposure under oxygen, or specifically, under inert gas, in order to obtain preliminary curing, and this is followed by thermal treatment at temperatures up to 160° C., specifically between 60 and 160° C., and then by final curing with electron beams or by UV exposure under oxygen or, specifically, under inert gas.

Optionally, if two or more coats of the coating material are applied one over the other, a drying and/or radiation cure may take place after each coating operation.

Radiation sources suitable for the radiation cure are, for example, low-pressure, medium-pressure, and high-pressure mercury lamps and also fluorescent tubes, pulsed lamps, metal halide lamps, electronic flash devices which allow radiation curing without photoinitiator, or excimer lamps. The radiation cure is accomplished by exposure to high-energy radiation, i.e., UV radiation, or daylight, specifically light in the wavelength range of λ=200 to 700 nm, more specifically of λ=200 to 500 nm, and very specifically λ=250 to 400 nm, or by bombardment with high-energy electrons (electronic radiation; 150 to 300 keV). Examples of radiation sources used include high-pressure mercury vapor lamps, lasers, pulsed lamps (flashlight), halogen lamps or excimer lamps. The radiation dose typically sufficient for crosslinking in the case of UV curing is in the range from 80 to 3000 mJ/cm².

It is of course also possible to use two or more radiation sources for the cure—for example, two to four.

These sources may also each emit in different wavelength ranges.

Drying and/or thermal treatment may also take place, in addition to or instead of the thermal treatment, by means of NIR radiation, with NIR radiation here referring to electromagnetic radiation in the wavelength range from 760 nm to 2.5 μm, specifically from 900 to 1500 nm.

Irradiation may optionally also be carried out in the absence of oxygen, such as under an inert gas atmosphere, for example. Suitable inert gases are specifically nitrogen, noble gases, carbon dioxide, or combustion gases. Moreover, irradiation may take place with the coating composition being covered with transparent media. Examples of transparent media are polymeric films, glass, or liquids, e.g., water. Particular preference is given to irradiation in the manner described in DE-A1 199 57 900.

When crosslinkers are also present which produce an additional thermal crosslinking, such as isocyanates, it is possible, simultaneously or else after the radiation cure, to carry out thermal crosslinking by raising the temperature to up to 150° C., specifically up to 130° C.

Figures in ppm and percent that are used in this specification relate, unless otherwise indicated, to weight percentages and to ppm by weight.

The examples which follow are intended to elucidate the invention, but not to restrict it to these examples.

### EXAMPLES

### Example 1 (Comparative)

67 parts of a high-functionality aliphatic urethane acrylate (Laromer® UA 9050, 80% strength in n-butyl acetate from BASF SE, corresponding to component (A) according to the invention) were mixed with 33 parts of 2-ethylhexyl acrylate and also with 0.2 part of EFKA® 2010 (defoamer, BASF SE), 0.3 part of EFKA® 3299 (flow control assistant, BASF SE, Ludwigshafen), 0.5 part of Tinuvin® 292 (HALS radical scavenger, BASF SE), 0.7 part of Tinuvin® 405 (UV absorber, BASF SE, Ludwigshafen), 1.3 parts of Irgacure® 754 (photoinitiator, BASF SE), 0.3 part of Lucirin® TPO (photoinitiator, BASF SE), and the mixture was stirred intensely for 30 minutes with protection from light in order to avoid photopolymerization. The viscosity was adjusted with additional n-butyl acetate to 50 mPas (cone/plate system, shear rate 40 000 l/s, at 23° C.).

This coating material 1 was applied by pneumatic spraying to a plastics substrate (PC/PBT Xenoy® CL101, GE Plastics, 100×150×3 mm) (clearcoat film thickness 35 μm) coated with a waterborne basecoat (film thickness 13 μm, Coatig™ Worwag Premium Basecoat (WB), from Karl Wörwag Lack-and Farbenfabrik GmbH & Co. KG).

After the varnish film had been flashed off at room temperature for 5 minutes, it was irradiated and cured using a 2 KW medium-pressure mercury lamp (UVASPOT® 2000, from Dr. Hönle AG) under a carbon dioxide atmosphere (residual oxygen content 1 volume %) at a distance of 60 cm for 80 seconds. After 3 days of storage at 60° C. and at 100% relative humidity, tests were carried out on the finished coating.

For flexibility testing, the coated plate was bent over a pipe with a diameter of 9 cm, with the uncoated reverse in contact with the pipe. Here, severe cracking was seen in the coating film.

For testing the chemical resistance, the coating was exposed to 1 drop in each case of 1% strength sulfuric acid, 1% strength aqueous sodium hydroxide solution, and 50% strength aqueous pancreatin solution (from Merck, Art. 7130) over 30 minutes, covered with glass dishes to prevent evaporation, at 55° C., and these chemicals were subsequently washed off, after which assessment took place. The surface remained without visible changes. The scratch resistance was determined by abraiding with an abrasive pad (Scotch Brite® 7448 Type S Ultra Fine, 3M) under a hammer with a weight of 500 g, with a contact area of 5 cm², after 50 double rubs, via the relative gloss difference (measurement angle 20°, micro-TRI-gloss® μ BYK-Gardner GmbH), and was found to be 65% relative residual gloss.

### Examples 2-10

Mixing Series for Increasing the Flexibility

The aliphatic urethane acrylate (Laromer® UA 9050) was blended with increasing amounts of 2-ethylhexyl acrylate, with addition of an aliphatic urethane acrylate having two acrylate groups and two isocyanate groups (Laromer® LR 9000, BASF SE Ludwigshafen, as component (C) according to the invention) for the purpose of assessing the compatibility limits (figures in parts by weight):

| | 2 | 3 | | | | | | | |
|---|---|---|---|---|---|---|---|---|---|
| | (comp.) | (comp.) | 4 | 5 | 6 | 7 | 8 | 9 | 10 |
| Laromer ® UA 9050 | 69 | 67 | 63 | 59 | 52 | 50 | 42 | 41 | 33 |
| Laromer ® LR 9000 | 0 | 0 | 3 | 3 | 13 | 13 | 18 | 18 | 26 |
| Ethylhexyl acrylate | 31 | 33 | 33 | 38 | 35 | 38 | 39 | 41 | 41 |
| Appearance | clear | hazy | clear | hazy | clear | hazy | clear | hazy | clear |

It is seen that by admixing Laromer® LR 9000 as component (C) it is possible to increase the proportion of 2-ethylhexyl acrylate in the mixture.

### Example 11

In accordance with Example 1, 100 parts of the mixture from Example 10 were admixed with 0.2 part of EFKA®2010 (BASF SE), 0.3 part of EFKA® 3299, 0.5 part of Tinuvin® 292 (BASF SE), 0.7 part of Tinuvin® 405, 1.3 parts of Irgacure® 754 (BASF SE), and 0.3 part of Lucirin® TPO (BASF SE), and the properties of the finished coating were tested accordingly.

The chemical resistance and scratch resistance (relative residual gloss 64%) were comparable to Example 1, but in the flexibility test there was no cracking.

It is seen that, by increasing the fraction of ethyl hexyl acrylate, a coating with a higher flexibility is obtained, and compatibility with the aliphatic urethane acrylate (component (A)) is ensured by admixing of component (C). In this way it is possible to formulate a clear coating material which has all of the properties of the coating material from comparative example 1 and additionally exhibits an increased flexibility.

1. A radiation-curable coating composition comprising
(A) at least one polyfunctional (meth)acrylate having a molecular weight of not more than 1000 g/mol and a functionality of at least four,
(B) at least one monofuctional alkyl(meth)acrylate, which, as a homopolymer, has a glass transition temperature of not more than 0° C.,
(C) at least one urethane(meth)acrylate which has at least one free isocyanate group and at least one (meth)acrylate group,
(D) at least one polyfunctional (meth)acrylate having a molecular weight of more than 1000 g/mol and a functionality of at least five,
(E) optionally, at least one solvent selected from the group consisting of hydrocarbons, ketones, esters, alkoxylated alkanoic acid alkyl esters, ethers, and mixtures thereof,
(F) optionally, at least one amine and/or alcohol,
(G) optionally, at least one photoinitiator, and
(H) optionally, at least one paint auxiliary.

2. The coating composition according to claim 1, wherein component (A) is selected from the group consisting of ditrimethylolpropane tetraacrylate, pentaerythritol tetraacrylate, and dipentaerythritol hexaacrylate.

3. The coating composition of claim 1, wherein the alkyl(meth)acrylates (B) are (meth)acrylic esters of alkanols which have 2 to 12 carbon atoms.

4. The coating composition of claim 1, wherein component (B) selected from the group consisting of ethyl acrylate, propyl acrylate, isopropyl acrylate, n-butyl acrylate, n-hexyl acrylate, n-octyl acrylate, 2-ethylhexyl acrylate, 3-propylheptyl acrylate, n-decyl acrylate, lauryl acrylate, n-pentyl methacrylate, n-octyl methacrylate, n-decyl methacrylate, and lauryl methacrylate.

5. The coating composition of claim 1, wherein component (C) is the reaction product
of at least one (cyclo)aliphatic diisocyanate or polyisocyanate (C1)
with at least one compound (C2) having at least one isocyanate-reactive group and at least one (meth)acrylate group and also
optionally, with at least one compound (C3) having at least two isocyanate-reactive groups.

6. The coating composition claim 1, wherein component (C) is a reaction product of a (cyclo)aliphatic diisocyanate with a hydroxyalkyl(meth)acrylate which has been obtained under reaction conditions under which both urethane groups and allophanate groups are formed, and so the (meth)acrylate groups are bonded at least partly via allophanate groups.

7. The coating composition of claim 1, wherein component (D) selected from the group consisting of polyester(meth)acrylates, epoxy(meth)acrylates, and urethane(meth)acrylates.

8. The coating composition of claim 1, wherein component (D) is a urethane (meth)acrylate having a (meth)acrylic group content of 1 to 5 mol per 1000 g of urethane(meth)acrylate.

9. The coating composition of claim 1, wherein component (E) selected from the group consisting of n-butyl acetate, ethyl acetate, acetone, and methyl acetate.

10. The coating composition of claim 1, comprising:
(A) 2 to 50 weight %,
(B) 5 to 90 weight %,
(C) 2 to 50 weight %,
(D) 1 to 40 weight %,
(E) 0 to 50 weight %,
(F) 0 to 10 weight %,
(G) 0 to 8 weight %,
(H) 0 to 15 weight %,
with the proviso that the sum total is always 100 weight %.

11. A process for producing the coating composition of claim 1,the process comprising introducing components (A), (C), and (D) as an initial charge and metering in component (B) with mixing until a single-phase mixture is obtained.

12. A process for producing the coating composition of claim 1, the process comprising introducing components (A), (B), and (D) as an initial charge and metering in component (C) with mixing until a two-phase mixture is obtained, followed by metering addition of additional component (B) and also, optionally, solvent (E).

13. A process for coating a substrate, the process comprising applying the coating composition of claim 1 to a substrate under an inert gas, then drying and curing under inert conditions with UV radiation.

14. (canceled)
